(19) United States
(12) Patent Application Publication
(10) Pub. No.: US 2007/0165226 A1
(43) Pub. Date: Jul. 19, 2007

(54) METHOD FOR OPTICALLY DETECTING LEAKS IN GAS-TIGHT HOUSING ESPECIALLY OF MICRO-ELECTRO-MECHANICAL SYSTEMS (MEMS)

(76) Inventor: Marcus Grigat, WESEL (DE)

Correspondence Address: WILLIAM COLLARD;COLLARD & ROE, P.C., 1077 NORTHERN BOULEVARD, ROSLYN, NY, 11576, US

(21) Appl. No.: 11/578,429

(22) PCT Filed: Apr. 15, 2005
(86) PCT No.: PCT/DE05/00795

§ 371 Date: Dec. 4, 2006

(30) Foreign Application Priority Data
Apr. 15, 2004 (DE) 10 2004 018 895.5

(51) Int. Cl. G01J 4/00

(52) U.S. Cl. 356/364

(57) ABSTRACT

The invention relates to a method for optically detecting leaks in gas-tight housings of especially micro-electro-mechanical systems (MEMS), wherein the objects to be tested are disposed in a pressure chamber covered by a glass plate and are impinged upon by pressure, and the resulting deformation of the object surface (membrane) and the subsequent receding change of the deformation is optically measured. The inventive method is characterized in that optical detection is carried out by means of a contactless profilometer (1) using a chromatic confocal sensor, whereby the glass plate (3) serving as the cover of the pressure chamber (8) is part of the optical system of the sensor.

The invention relates to a method for optical detection of leaks in gas-tight housings, particularly of micro-electronic systems (MEMS), in which the deformation of the object surface (membrane) resulting from pressure impact on the objects disposed in a pressure chamber covered with a glass plate, and the subsequent reverse status change of this deformation are optically measured.

Such a method is described in the article “Optical Leak Testing of hermetic opto-electronic devices,” John W. Newman, 1995, although this is a method for testing opto-electronic devices, whereby the housings of these devices are covered with metal lids that are soldered, welded, or glued onto the housing opening. In order to prevent oxygen or other contaminants from getting on the contacts and precisely ground optical surfaces situated in the housing, these lids have to be applied to the housing in particularly sealed manner.

The object to be tested is laid into a pressure container that can be filled with helium. The helium now exerts a pressure onto the object, whereby the lid bends slightly into the interior of the housing. If there is now a leak, pressure equalization takes place over time, and the bending is caused to reverse.

The leak rate can be calculated from the time progression of the return to the starting position.

In the state of the art, the bending of the lid is measured using a digital holographic camera, whereby of course a great optical effort must be performed for generation of the hologram. The optical system, which consists of several beam splitters, lenses, and mirrors, requires precise adjustment and is therefore susceptible to shocks and contaminants.

The invention is therefore based on the task of conducting a method of the type stated initially with significantly less technical effort, and nevertheless achieving excellent measurement accuracy.

The invention accomplishes this task in accordance with the characterizing part of claim 1, in that the optical detection takes place by means of a profilometer that works without contact, using a chromatic confocal sensor, whereby the glass plate that serves as a cover for the pressure chamber is part of the optical system of the sensor.

The optical system of such a surface measurement device consists essentially of a polychromatic point light source (in other words no laser is required), a lens, and a dispersive plate disposed between lens and object.

To take the picture, all that is required is a semi-permeable mirror, which transmits the picture taken to a CCD camera, for example.

This optical structure, which is already quite simple, in and of itself, is simplified even further, according to the invention, in that the dispersive plate is now part of the pressure chamber, namely the lid of this chamber, which is configured as a glass plate.

The chamber is mounted on the table of the device, which table can be moved in the x-y direction. In this manner, it is now possible to scan the objects (MEMS) to be examined, which are present in multiple numbers on a wafer, which is disposed in the pressure chamber as a whole, point by point, i.e. object by object, whereby the deformation of the membranes or other surfaces of the objects to be tested, brought about by the gas pressure in the chamber, is measured. Such objects can be, for example, pressure sensors or acceleration sensors on a micro-scale.

The advantage of this optical-mechanical structure with the glass lid of the pressure chamber as part of the optical system of the confocal sensor lies in the fact that a very short work distance and a very great z (height) resolution exist. The glass lid, which should have a thickness between 5 and 10 mm, preferably 7 mm for use in the case of wafers, does not result in an increase in the work distance, since it is part of the optics. As part of the sensor, it also does not disturb the sensor itself, either.

It was possible to show that the mechanical attachment of the glass plate on the pressure chamber is sufficient. The bending of the glass plate, which is dependent on the pressure, and the inclination of the lid, which is dependent on the pressure, are eliminated by means of electronic image processing.

The method is conducted as follows:

The complete wafer is placed into the pressure chamber and the test is conducted fully automatically. All the hermetically sealed components on the wafer are individually scanned with a scanning time t_{S} (between 10 and 20 sec), resulting in a scanning time t_{SW}=t_{S}*N, whereby N is the number of objects on the wafer. After the first reference scanning procedure, at a pressure of p₀, the helium pressure is switched to p_{W}. Afterwards, the scanning procedure is repeated over the complete wafer, specifically at least twice. Thus the complete testing time per wafer is t_{wf}=3*N*tₛ, and the helium impact time is t_{b}=t_{SW}=N*t_{S}.

As an example, a typical wafer has 2400 objects, whereby a scanning time t_{S} of 12 sec per object is provided. Since measurements are taken three times, in the present example, this results in a cycle time of 36 sec per object. This means that a helium impact time of 8 hours per wafer is required, and thus a high resolution for the leak rate at a total measurement time of 24 hours per wafer.

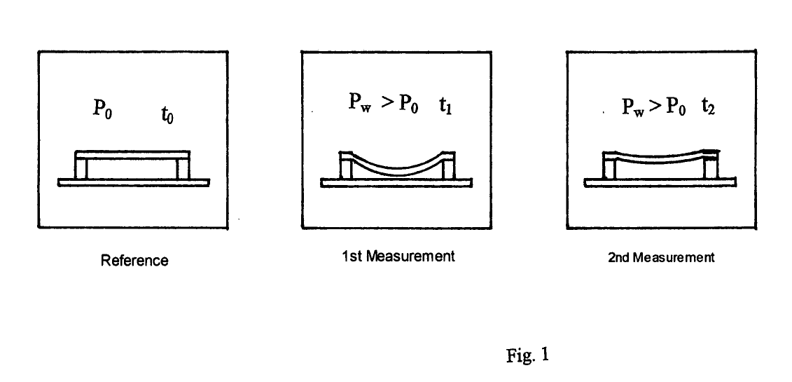

FIG. 1 shows the principle of the optical leak test. At the time t₀, the test object in the pressure chamber is under a helium pressure p₀. At the time t₁, the helium pressure is switched to p_{W}. The deformation of the object surface is measured. Large leaks can be recognized in that no membrane deformation takes place, since a pressure equalization that is practically immediate takes place between the pressure chamber and the interior of the test object. The measurement is repeated at tᵢ (i=2, 3, . . . , n).

The leak rate is calculated from the time-dependent relaxation of the membrane deformation.

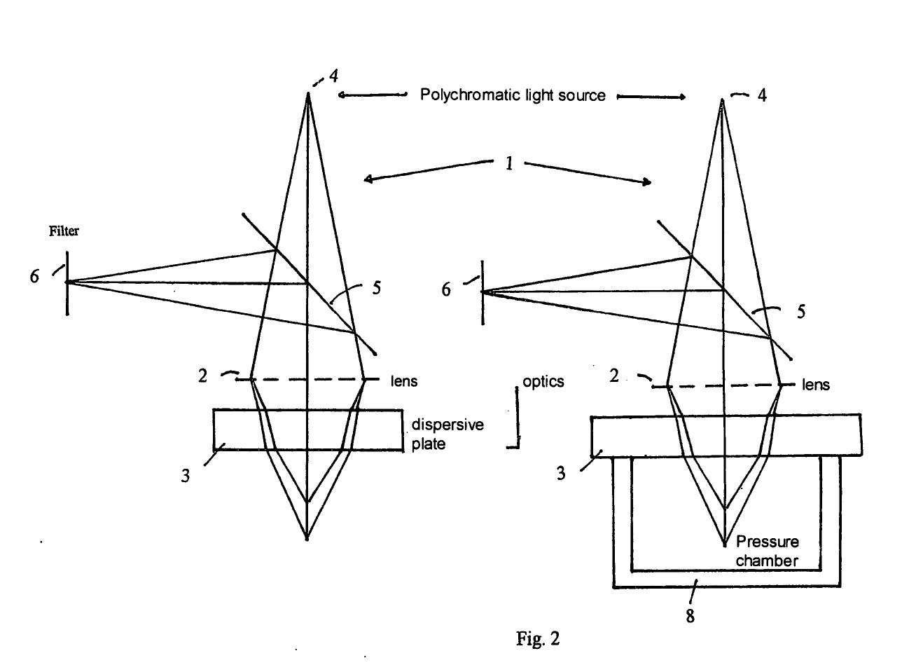

FIG. 2, in the left drawing, shows a surface measurement device 1 (profilometer) according to the invention. The optical system of this sensor consists essentially of a lens 2 and a dispersive glass plate 3, which is situated between the lens 2 and the object to be tested (not shown). In the present case, the light source is a polychromatic point source 4. The light reflected by the object to be tested is transmitted to a digital camera, not shown, by means of a semi-permeable mirror 5, by way of a filter 6.

Since the method of operation of such a confocal sensor is known, this technology will not be discussed in greater detail.

As is evident from the right drawing of FIG. 2, the dispersive plate 3 of the optical system is replaced with the glass plate that forms the lid of the pressure chamber 8.

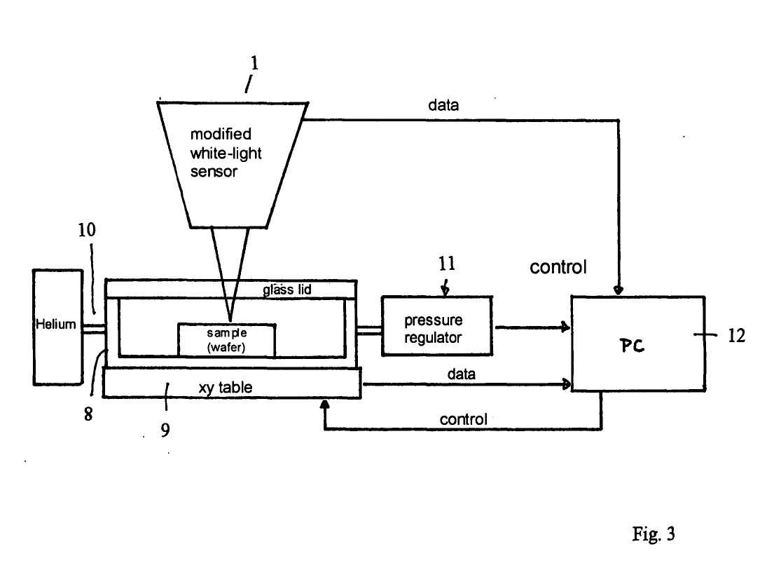

As is furthermore evident from FIG. 3, the pressure chamber 8 is mounted on a table 9 that can move in the x-y direction. The pressure chamber 8 has an input valve 10 for helium and a pressure regulator 11.

The pressure regulator 11 is connected with a computer 12, in terms of data. The surface measurement device 1 is also connected with this computer 12, in terms of data, just like the table that can be moved in the x-y direction, which is furthermore controlled by the PC.

1. Method for optical detection of leaks in gas-tight housings, particularly of micro-electronic systems (MEMS), in which the deformation of the object surface (membrane) resulting from pressure impact on the objects disposed in a pressure chamber covered with a glass plate, and the subsequent reverse status change of this deformation are optically measured,
wherein
the optical detection takes place by means of a profilometer (1) that works without contact, using a chromatic confocal sensor, whereby the glass plate (3) that serves as a cover for the pressure chamber (8) is part of the optical system of the sensor.

2. Method according to claim 1,
wherein
helium is used for pressure impact.

3. Method according to claim 1
wherein after pressure application, the deformation of the surface of the objects to be tested is measured, and this measurement is repeated at defined intervals, and the leak rate is calculated from the time-dependent relaxation of the membrane deformation.

4. Method according to claim 1,
wherein
the objects (MEMS) are generated in multiple numbers next to one another on a wafer, by means of microtechnology, whereby each object on the wafer is individually tested, in such a manner that the sensor first works at a pressure p₀, with a scanning time t_{S}, in each instance, so that the wafer scanning time is t_{SW}=t_{S}*N (N =number of objects), and that after this reference measurement, the pressure is increased to P_{w} and the scanning procedure is repeated over the entire wafer, at least twice.

5. Method according to claim 1,
wherein
the pressure-dependent bending of the glass plate (3) is eliminated by means of image processing.

6. Device for implementing the method according to claim 1,
wherein
a pressure chamber (8) covered with a glass plate (3) is mounted on a table (9) that can move in the x-y direction, whereby this glass plate (3) is the dispersive element of the optics of a profilometer (1) disposed above the pressure chamber (8), in the form of a chromatic confocal sensor.

7. Device according to claim 6,
wherein the pressure chamber (8) has an inlet (10) for the pressure gas, a pressure regulator (11), and this pressure regulator (11) is connected with a computer (12), in terms of data, which is furthermore connected with the confocal sensor (1) and the table (9) that can be moved in the x-y direction, which in turn is controlled by the computer (12).

8. Device according to claim 6
wherein the glass plate (3) has a thickness of 5 to 10 mm.
